(19) United States
(12) Patent Application Publication
(10) Pub. No.: US 2001/0013099 A1
(43) Pub. Date: Aug. 9, 2001

(54) Software license management method, electronic device, and recording medium

(75) Inventor: Kosuke Haruki, Ome-shi (JP)

Correspondence Address: Finnegan, Henderson, Farabow, Garrett & Dunner, L.L.P., 1300 I Street, N.W., Washington, DC, 20005-3315, US

(73) Assignee: KABUSHIKI KAISHA TOSHIBA

(21) Appl. No.: 09/772,905

(22) Filed: Jan. 31, 2001

(30) Foreign Application Priority Data
Feb. 1, 2000 (JP) 2000-024163

(51) Int. Cl. G06F 11/30; H04L 9/00

(52) U.S. Cl. 713/202

(57) ABSTRACT

An electronic device determines, upon receiving an acquisition request of license data necessary for installing the software or executing a specific function of the software, whether or not license data is issued by referring to management data indicating issue status of license data, stored in a secret area in the electronic device and controls permission or inhibition of issuing the license data stored in the secret area in the electronic device based on the determination result.

### CROSS-REFERENCE TO RELATED APPLICATIONS

This application is based upon and claims the benefit of priority from the prior Japanese Patent Application No. 2000-024163, filed Feb. 1, 2000, the entire contents of which are incorporated herein by reference.

### BACKGROUND OF THE INVENTION

The present invention relates to a software license management method, electronic device, and recording medium and, more particularly, to a software license management method capable of processing various digital contents such as image data or music data, an electronic device, and a recording medium.

Conventionally when software such as an operating system or application program is to be installed in a personal computer, the user must input a serial number or the like in order to prove that the user holds a rightful license.

For example, when an operating system recorded on a CD-ROM medium is to be installed, the user must input a CD key unique to the CD-ROM medium. In general, a serial number such as a CD key is described in a manual or license agreement packaged with the software distribution package. The user inputs the serial number via a keyboard.

With the conventional method of causing the user to input a serial number such as a CD key, however, it is actually difficult to inhibit him or her from installing software in a plurality of personal computers exceeding the range permitted by the license.

Recently, various software programs for processing digital contents such as image data or music data have been developed, and playback and copying of digital contents and download to another device can be easily performed by a computer. For this reason, measures against illicit use of software are becoming more and more important in terms of copyright protection of digital contents.

### BRIEF SUMMARY OF THE INVENTION

The present invention has been made in consideration of the above situation, and has as its object to provide a software license management method which can reliably prevent illicit use of software and is suitable for protection of software and contents processed by the software, an electronic device, and a recording medium.

To solve the above problems, according to the present invention, a license management method for contents-processing software for downloading contents data from a computer to an electronic device in a state in which the computer is connected to the electronic device, comprises the steps of: determining, by the electronic device, upon receiving an acquisition request of license data necessary for installing the software or executing a specific function of the software, whether or not license data is issued by referring to management data indicating issue status of license data, stored in a secret area in the electronic device; and controlling permission or inhibition of issuing the license data stored in the secret area in the electronic device based on the determination result.

The license management method uses a computer and an electronic device connectable to the computer. The electronic device has a secret area which cannot be accessed from a file system or the like. License data, and management data for managing a license data issue history are prepared in the secret area. In installing software or executing a specific function of the software, the software issues a license data acquisition request to the electronic device. Whether to issue license data for the acquisition request is determined in the electronic device using the management data. These license data and management data are hidden, and used to limit the use of the software using the license data and management data. This can reliably prevent the user from installing the software in a plurality of personal computers exceeding the range permitted by the license, or using a function out of the range permitted by the license.

As the management data, data for managing whether the license data has not been issued can be used. By using, as the management data, ID data for identifying a computer which has issued the license data, the original license management “one license for one computer” can be reliably achieved. If a plurality of memory areas for registering a plurality of ID data are prepared in the secret area, the license can also be managed for a plurality of computers.

The present invention preferably employs a mechanism of returning the contents of management data in the electronic device to a state preceding issue of license data in response to an uninstall notification from the software. With this mechanism, even when the user bought a new computer, the software can be reinstalled in the new computer.

The above-described electronic device for managing license data includes a contents playback device for recording and playing back contents transferred from the computer. In this case, the software manages contents transfer to the contents playback device (e.g., a count capable of transferring contents from the computer to the electronic device is limited to a predetermined count in advance, and the software manages such transfer).

Since the license of software for transferring contents to the contents playback device is managed using the contents playback device, the license of the software can be managed without preparing any dedicated license management hardware. Since the contents transfer software and contents playback device have one-to-one correspondence, a computer in which the contents transfer software is installed, and the contents playback device can also basically have one-to-one correspondence, and contents transfer to the contents playback device can be limited.

In transferring contents, authentication is preferably done between the contents playback device and the software using license data in the contents playback device prior to contents transfer. Thus, contents cannot be transferred from another software to the contents playback device, and illicit contents transfer to the contents playback device can be reliably prevented.

The present invention can reliably prevent illicit use of software, and can realize license management suitable for protection of software and contents processed by the software.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing a system configuration for realizing a software license management method according to an embodiment of the present invention;

FIGS. 2A and 2B are views for explaining a processing sequence in installing software that is used in the embodiment;

FIGS. 3A and 3B are views for explaining a processing sequence in uninstalling software that is used in the embodiment;

FIG. 4 is a view for explaining license management operation in transferring contents that is used in the embodiment;

FIG. 5 is a view for explaining authentication processing operation in transferring contents in the embodiment;

FIG. 6 is a view for explaining a case wherein license data is managed using a PC-ID in the embodiment;

FIG. 7 is a view for explaining a case wherein license data is managed using a plurality of PC-IDs in the embodiment;

FIG. 8 is a view showing the internal memory of a contents playback device when a plurality of license data are the same;

FIG. 9 is a flow chart showing the processing sequence in installing software that is used in the embodiment;

FIG. 10 is a flow chart showing the processing sequence in uninstalling software that is used in the embodiment; and

FIG. 11 is a block diagram showing another example of the system configuration for realizing the software license management method according to the embodiment.

### DETAILED DESCRIPTION OF THE INVENTION

An embodiment of the present invention will be described below with reference to the several views of the accompanying drawing.

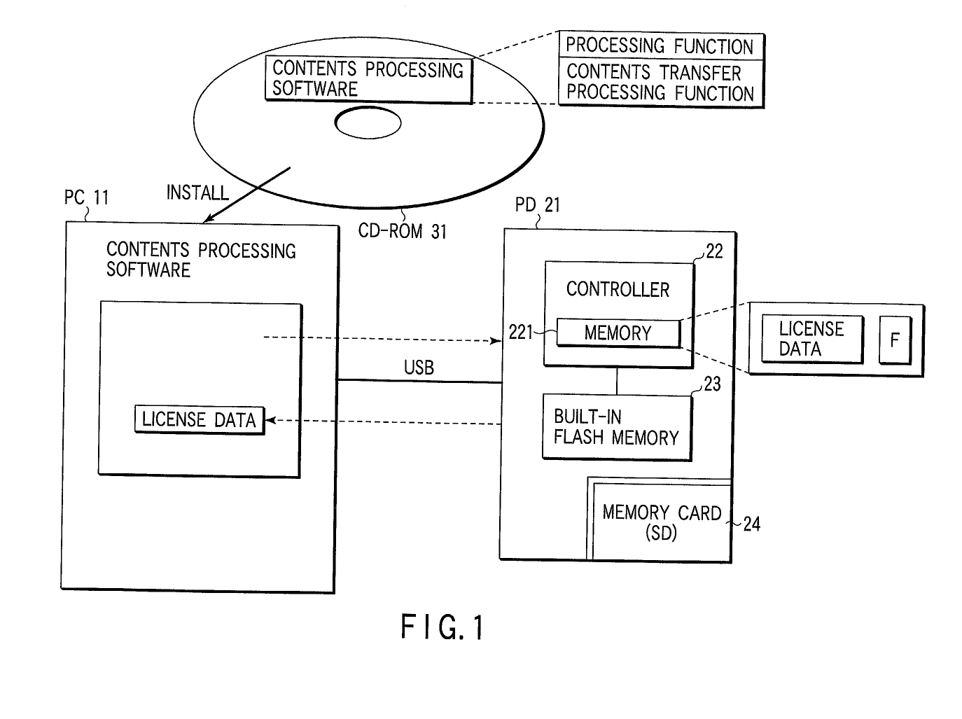

FIG. 1 shows a system configuration for realizing a software license management method according to the embodiment of the present invention. Assume that contents processing software as an application program for, e.g., playing back digital contents such as image data or music data is installed and used in a PC (Personal Computer) 11.

The contents processing software is implemented as tamper resistant software (TRS). The tamper resistant software (TRS) means software having a defense function against attack such as illicit internal analysis or tampering. The contents processing software mainly comprises a CODEC processing function of coding/decoding digital contents in order to play back the digital contents, and a contents transfer processing function of transferring (downloading) digital contents to a portable contents playback device (PD; Portable Device) 21.

Contents transfer to the contents playback device 21 is managed and controlled by the contents processing software. License data (made up of, e.g., a 96-bit numerical string such as a user ID) necessary for installing the contents processing software or executing the contents transfer processing function is managed by the contents playback device (PD) 21. The contents processing software is recorded on a read-only recording medium such as a CD-ROM 31, and sold together with the contents playback device (PD) 21.

The contents playback device (PD) 21 records and plays back digital contents such as image data or music data. The contents playback device (PD) 21 downloads digital contents coded in an MPEG2 format, an MPEG3 format, or another format from the PC 11, and plays them back. Although the contents playback device (PD) 21 is generally used as a single device, the contents playback device (PD) 21 has a USB (Universal Serial Bus) interface as a communication interface for communicating with the PC 11, and can be used while being connected to the PC 11 via the USB. Digital contents are downloaded from the PC 11 via the USB. Communication between the PC 11 and the contents playback device (PD) 21 that is necessary for exchange of license data is also performed via the USB.

As shown in FIG. 1, the contents playback device (PD) 21 comprises a controller 22 and built-in flash memory 23. The controller 22 is hardware for performing recording/playback control of contents, and communication control with the PC 11, and has an internal memory 221 formed from an electrically erasable nonvolatile memory or the like. The internal memory 221 is a secret memory area which cannot be accessed by the user or the file system of the PC 11, and stores the above-mentioned license data (e.g., unique serial number) in advance. A management flag (F) for managing a license data issue history is also prepared in the internal memory 221. The management flag (F) is data for managing the license data issue history, i.e., whether license data has not been issued. Permission/inhibition of issuing license data is determined using the management flag (F).

The built-in flash memory 23 is a nonvolatile memory for storing digital contents downloaded from the PC 11. Digital contents downloaded from the PC 11 can also be stored in a memory card 24 which can be freely attached to the contents playback device (PD) 21. The memory card 24 preferably has a rightful copy protection function, such as an SD (Secure Digital) card.

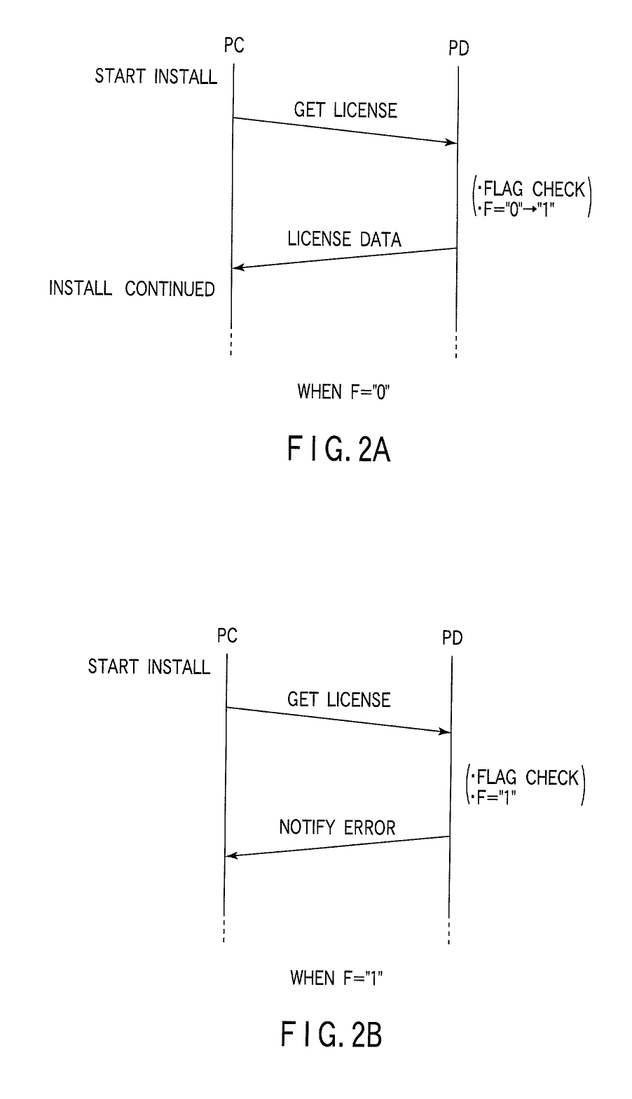

A method of limiting install of the contents processing software using license management data will be explained with reference to FIGS. 2A and 2B. Assume that the contents processing software can only be installed once for each PC in terms of the license. FIG. 2A shows a case wherein license management data has not been issued yet (F=“0”), and FIG. 2B shows a case wherein license management data has been issued (F=“1”).

(Step S1): The contents processing software is installed while the PC 11 is connected to the contents playback device (PD) 21. When install of the contents processing software starts, a license data acquisition request (“get license”) is issued from the contents processing software to the contents playback device (PD) 21 during install processing, and sent to the contents playback device (PD) 21 via the USB.

(Step S2): The controller 22 of the contents playback device (PD) 21 checks the management flag F in the internal memory 221, and determines whether license data has already been issued.

(Step S3): When the management flag F=“0”, i.e., license data has not been issued, the controller 22 rewrites the management flag F to “1”, issues license data, and transfers it to the contents processing software on the PC 11 via the USB (FIG. 2A). The contents processing software permits continuous execution of its install processing on the condition that rightful license data is acquired. Accordingly, the contents processing software can be normally installed.

(Step S4): To the contrary, when the management flag F=“1”, i.e., license data has already been issued, the controller 22 inhibits issue of license data, and sends back an error notification to the contents processing software on the PC 11 via the USB (FIG. 2B). In this case, install processing of the contents processing software ends as an error at this time.

Since the license data and management flag F are managed in the secret area in the contents playback device (PD) 21, this can reliably prevent the user from installing the contents processing software in a plurality of personal computers exceeding the range permitted by the license.

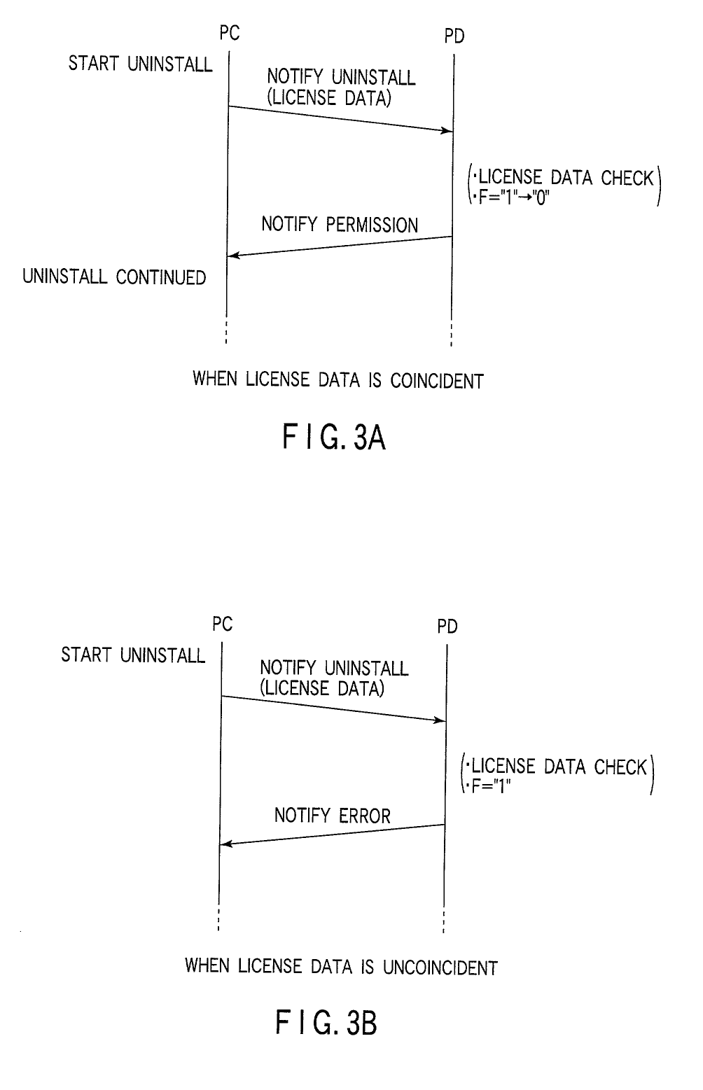

Processing in uninstalling the contents processing software will be explained with reference to FIGS. 3A and 3B.

(Step S1): The contents processing software is also uninstalled while the PC 11 is connected to the contents playback device (PD) 21. When uninstall of the contents processing software starts, an uninstall notification representing uninstall of the contents processing software is issued from the contents processing software to the contents playback device (PD) 21 during uninstall processing, and sent to the contents playback device (PD) 21 via the USB. This uninstall notification also includes license data of the contents processing software.

(Step S2): The controller 22 of the contents playback device (PD) 21 checks license data in the internal memory 221, and determines whether the license data included in the uninstall notification is coincident with the license data in the internal memory 221.

(Step S3): When the license data is coincident, i.e., an uninstall notification has been issued from rightful contents processing software, the controller 22 rewrites the management flag F from “1” to “0”, issues an uninstall permission notification, and transfers it to the contents processing software on the PC 11 via the USB (FIG. 3A). The contents processing software which has received the uninstall permission notification continuously executes its uninstall processing.

(Step S4): To the contrary, when the license data is not coincident, i.e., an uninstall notification has been issued from contents processing software other than rightful contents processing software which has received license data from the contents playback device (PD) 21, the controller 22 sends back an error notification to the software on the PC 11 via the USB while holding the management flag F to “1” (FIG. 3B). In this case, uninstall processing of the contents processing software ends as an error at this time.

With the mechanism of returning the contents of the management flag F to a state preceding issue of license data in response to an uninstall notification from rightful contents processing software, even when the user bought a new PC 11, the contents processing software can be reinstalled in the new computer.

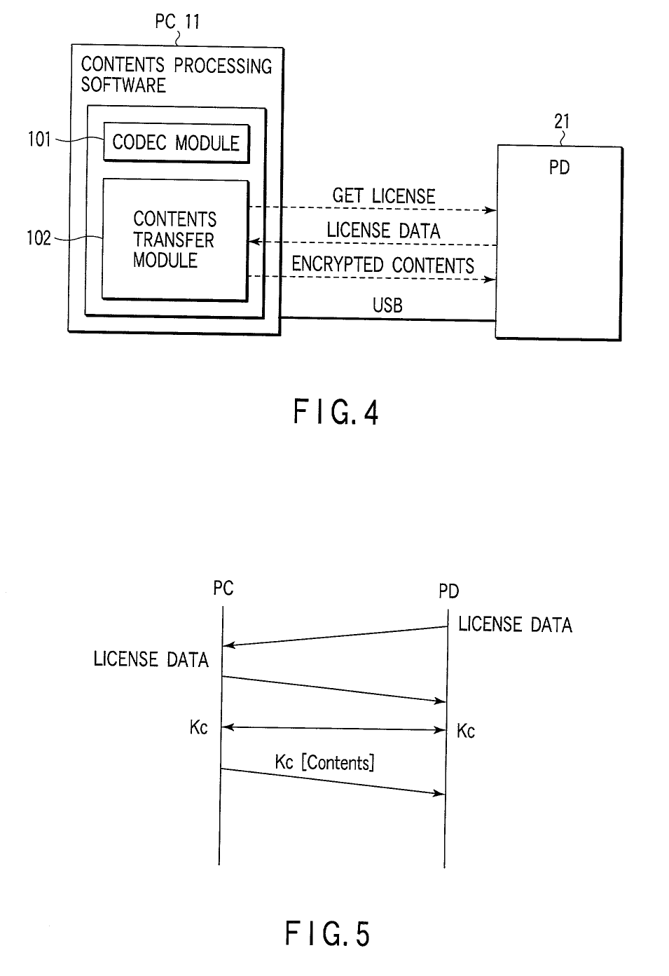

A method of limiting not install of the contents processing software but the use of the contents transfer processing function using license management data will be explained with reference to FIG. 4.

As shown in FIG. 4, the contents processing software is made up of a CODEC module 101 for performing the above-described CODEC processing function, and a contents transfer module 102 for performing the above-described contents transfer processing function. Install of the contents processing software is not particularly limited, and install processing of the contents processing software is executed by a general license management method using a serial number. For example, a file such as a wave file which stores music data requires a large memory capacity, so that the file is generally created as a compressed MP3 or AAC file. This file is large in file size, so that it is generally stored in a hard disk device or the like on the PC side, and subjected to ripping processing to transfer an MP3 or AAC file to a contents playback device. For this reason, install of the contents processing software is not especially limited.

When the user uses the contents transfer processing function of the contents processing software for the first time, the following processing is executed between the contents transfer module 102 and the contents playback device (PD) 21.

(Step S1): A license data acquisition request (“get license”) is issued from the contents transfer module 102 to the contents playback device (PD) 21, and sent to the contents playback device (PD) 21 via the USB.

(Step S2): The controller 22 of the contents playback device (PD) 21 checks the management flag F in the internal memory 221, and determines whether license data has already been issued.

(Step S3): When the management flag F=“0”, i.e., license data has not been issued, the controller 22 rewrites the management flag F to “1”, issues license data, and transfers it to the contents processing software on the PC 11 via the USB. The contents transfer module 102 which has acquired rightful license data encrypts, by a predetermined algorithm, contents designated as a transfer target by the user, and transfers the encrypted contents to the contents playback device (PD) 21 (check out).

(Step S4): To the contrary, when the management flag F=“1”, i.e., license data has already been issued, the controller 22 inhibits issue of license data, and sends back an error notification to the contents processing software on the PC 11 via the USB. In this case, the use of the contents transfer module 102 is inhibited at this time, and no contents are transferred to the contents playback device (PD) 21.

In this manner, the license management method of the embodiment can be used not only to install software but also to limit the use of a specific function of the software.

In actual contents transfer processing, authentication processing is preferably done between the contents processing software and the contents playback device (PD) 21 every time contents transfer processing is executed.

(Step S1): Authentication processing of confirming whether the contents processing software and contents playback device (PD) 21 are rightful partners is performed by exchanging license data between the contents processing software and the contents playback device (PD) 21.

(Step S2): If authentication succeeds to confirm that the contents processing software and contents playback device (PD) 21 are rightful partners, keys are exchanged between the contents processing software and the contents playback device (PD) 21 by a method using a random challenge response such as a CSS (Contents Scrambling System) used as the contents encryption algorithm of a DVD-ROM, or a method such as DTCP (Digital Transmission Contents Protection) used as an IEEE 1394 contents encryption algorithm. As a result, the contents processing software and contents playback device (PD) 21 share the same private key (contents key Kc). The contents key Kc is a time-variant key which changes every time.

(Step S3): The contents transfer module 102 uses the contents key Kc to encrypt contents designated as a transfer target by the user, and transfers the encrypted contents (Kc[Contents]) to the contents playback device (PD) 21.

(Step S4): The contents playback device (PD) 21 uses the contents key Kc to decrypt the encrypted contents, and plays back the decrypted contents.

(Step S5): When the encrypted contents (Kc[Contents]) are to be recorded on the memory card 24 (SD card), the contents key Kc is encrypted using identification data (medium ID) unique to the memory card 24 after authentication processing between the controller 22 and the memory card 24. Then, the encrypted contents key Kc is recorded on the memory card 24 together with the encrypted contents (Kc[Contents]). Since encryption of the contents is managed using the medium ID, the contents can also be played back by another playback device by attaching the memory card 24 to this playback device having a rightful copy protection function.

In this way, authentication processing using license data is done between the contents processing software and the contents playback device (PD) 21 prior to transfer of the contents. In install or in executing a specific function, software other than rightful contents processing software which has acquired license data from the contents playback device (PD) 21 cannot transfer contents to the contents playback device (PD) 21, which can prevent illicit contents transfer to the contents playback device (PD) 21.

A license management method using an identifier (PC-ID) unique to an install destination PC will be described.

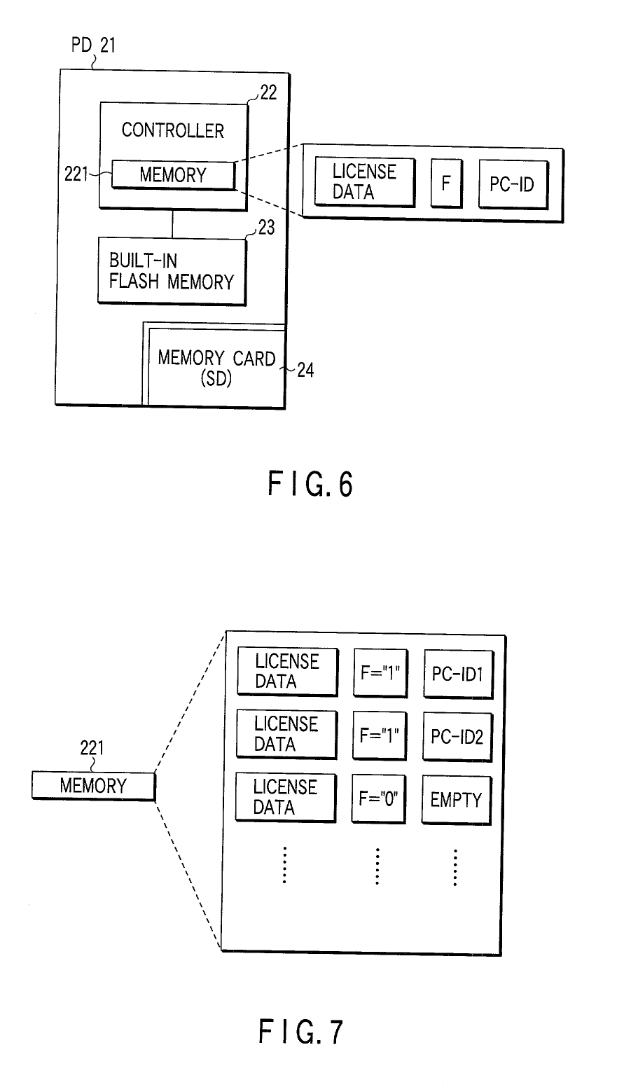

In this case, as shown in FIG. 6, a PC-ID memory area is prepared in the built-in memory 221 of the contents playback device (PD) 21 in addition to the above-mentioned license data and management flag (F). The PC-ID memory area stores ID data (PC-ID) for identifying a partner PC which has issued license data. A license data issue history and issuing PC are managed using the PC-ID memory area. For a PC which has rightfully issued license data once, its PC-ID is held in the contents playback device (PD) 21. Even if the contents processing software is erased due to a PC problem or initialization of a hard disk device in the PC, the contents processing software can be reinstalled, and the original license management “one license for one computer” can be reliably achieved.

As shown in FIG. 7, a plurality of sets of license data, management flag (F), and PC-ID memory area may be stored in the internal memory 221 in advance. This can realize, for example, a license condition “contents processing software can only be installed once for one PC, but can be installed up to three PCs.”

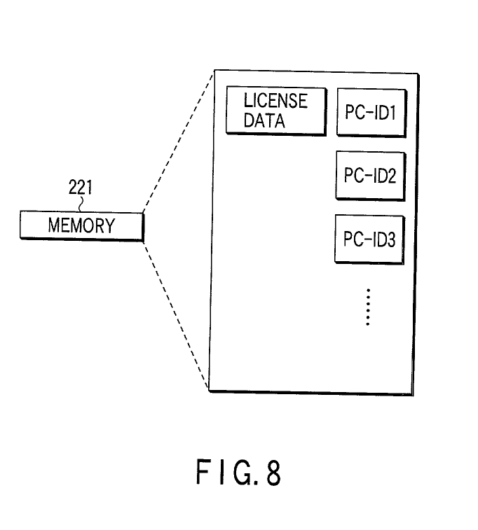

Note that the contents of each PC-ID memory area can also be used as the management flag (F) depending on registration/non-registration of the PC-ID. In this case, no management flag (F) is especially required. That is, a case wherein a PC-ID is registered can be interpreted as F=“1”, and a case wherein no PC-ID is registered can be interpreted as F=“0”. When a plurality of license data have the same contents, only one license data may be stored in the internal memory 221 in advance, as shown in FIG. 8.

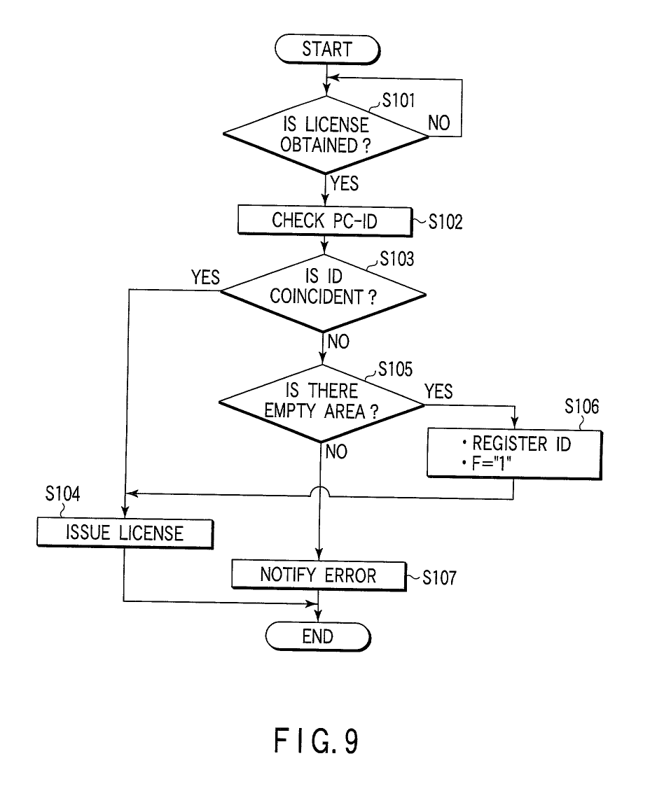

The internal operation of the contents playback device (PD) 21 that is executed for a license data acquisition request (“get license”) from the contents processing software will be explained with reference to the flow chart of FIG. 9.

As described above, in installing the contents processing software or in activating the contents transfer processing function for the first time, the contents processing software issues a license data acquisition request (“get license”) to the contents playback device (PD) 21. The license data acquisition request (“get license”) includes the PC-ID of the PC 11. The PC-ID can utilize various IDs as far as data is unique to each PC. For example, the PC-ID is an ID acquired from the BIOS by the contents processing software itself at the start of installing the contents processing software. Alternatively, it is also possible to generate a PC-ID unique to a PC using an ID acquired from the OS or the like, and store the PC-ID in the internal disk device of the PC. In this case, the PC-ID is preferably encrypted and recorded in the disk device. Alternatively, the PC-ID may be hidden by dispersedly storing a plurality of components constituting the PC-ID in the registry of the OS or the like.

Upon reception of the license data acquisition request (“get license”) including the PC-ID (YES in step S101), the controller 22 of the contents playback device (PD) 21 checks whether a PC-ID coincident with the PC-ID designated by the license data acquisition request exists in the internal memory 221 (step S102). If a coincident PC-ID exists (YES in step S103), the controller 22 issues license data to the contents processing software (step S104).

If no coincident PC-ID exists (NO in step S103), the controller 22 checks whether a PC-ID memory area where no PC-ID is registered exists (step S105). If an empty PC-ID memory area exists (YES in step S105), the controller 22 registers a PC-ID designated by the license data acquisition request in the PC-ID memory area, rewrites the corresponding management flag F to “1” (step S106), and issues license data to the contents processing software (step S104).

If no empty PC-ID memory area exists (NO in step S105), the controller 22 inhibits issue of license data, and sends back an error notification to the contents processing software (step S107).

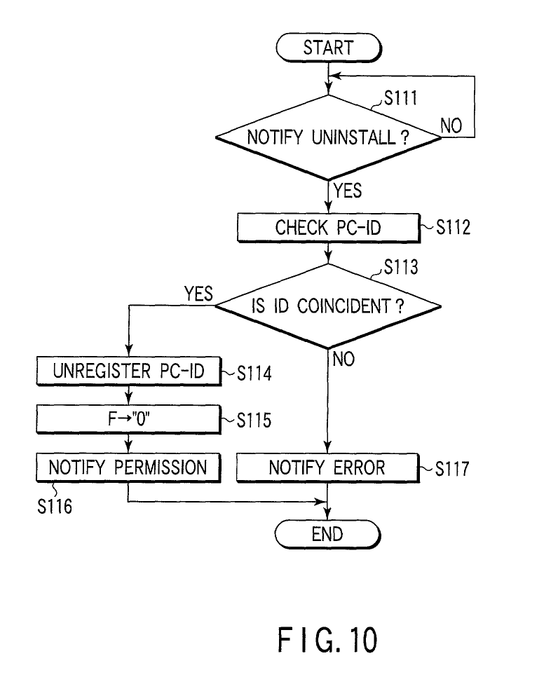

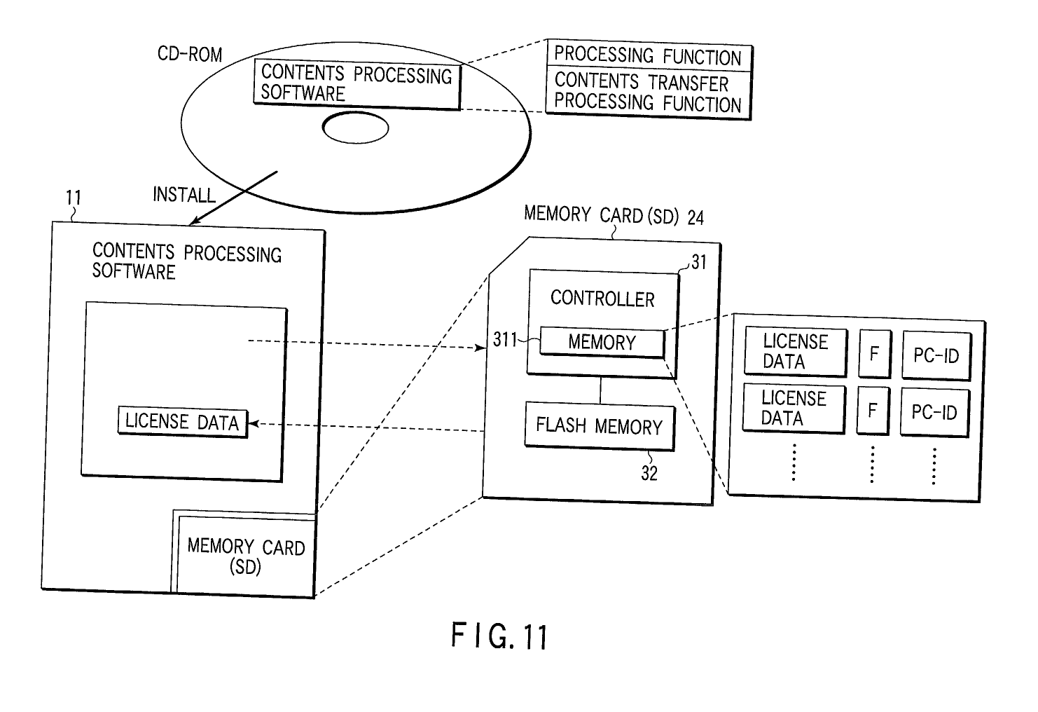

FIG. 10 shows a processing sequence for an uninstall notification.

As described above, in uninstalling the contents processing software, the contents processing software issues an uninstall notification to the contents playback device (PD) 21. This uninstall notification includes a PC-ID.

Upon reception of the uninstall notification including the PC-ID (YES in step S111), the controller 22 of the contents playback device (PD) 21 checks whether a PC-ID coincident with the PC-ID designated by the uninstall notification exists in the internal memory 221 (step S112).

If a coincident PC-ID exists (YES in step S113), the controller 22 deletes registration of the PC-ID to change the corresponding PC-ID memory area to an unregistered state (step S114), and rewrites the corresponding management flag F from “1”s to “0” (step S115). Then, the controller 22 issues an uninstall permission notification to the contents processing software (step S116).

If no coincident PC-ID exists (NO in step S113), the controller 22 issues an error notification to the contents processing software to inhibit uninstall processing (step S117).

FIG. 11 shows the second example of the system configuration for realizing the software license management method according to this embodiment.

This example is the same as in FIG. 1 except that the above-described license management data, management flag F, and PC-ID are registered in the memory card 24 which can be freely attached to the PC 11 or contents playback device 21.

As shown in FIG. 11, the memory card 24 has a controller 31 and built-in flash memory 32. The controller 31 is hardware for performing recording control of contents, and communication control with the PC 11, and has an internal memory 311 formed from an electrically-erasable nonvolatile memory or the like. The internal memory 311 is a secret memory area which cannot be accessed by the file system of the PC 11 or the like, and stores the above-mentioned license data in advance. A management flag (F) for managing a license data issue history, and a PC-ID memory area are also prepared in the internal memory 311.

Install/uninstall of the contents processing software, and contents transfer from the PC 11 to the memory card 24 are performed while the memory card 24 is inserted in the PC card slot of the PC 11. The license is managed similarly to the system in FIG. 1 except that not the controller 22 in the contents playback device (PD) 21 but the controller 31 in the memory card 24 communicates with the contents processing software.

As has been described above, this embodiment manages license data using a secret area in an electronic device (contents playback device, memory card, or the like) serving as hardware which can be used by connecting the PC 11. Hence, license management which meets license conditions can be reliably practiced.

Note that communication between the PC 11 and the contents playback device 21 uses the USB in the embodiment, but may use an IEEE 1394 or a radio interface such as a Bluetooth.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A license management method for contents-processing software for downloading contents data from a computer to an electronic device in a state in which the computer is connected to the electronic device, comprising the steps of:
determining, by the electronic device, upon receiving an acquisition request of license data necessary for installing the software or executing a specific function of the software, whether or not license data is issued by referring to management data indicating issue status of license data, stored in a secret area in the electronic device; and
controlling permission or inhibition of issuing the license data stored in the secret area in the electronic device based on the determination result.

2. A method according to claim 1, wherein
the control step controls to issue the license data to the computer when the determination result indicates that the license data has not been issued, and to inhibit the issuance of the license data when the determination result indicates that the license data has been issued.

3. A method according to claim 1, wherein
ID data for identifying a computer which has issued the license data is registered as the management data in the secret area, and
permission or inhibition of issuing the license data for the acquisition request is determined by the controller of the electronic device, on the basis of whether the ID data has not been registered and whether the ID data is coincident with ID data of the computer which has issued the acquisition request.

4. A method according to claim 1, wherein a plurality of memory areas for registering a plurality of ID data are prepared in the secret area.

5. A method according to claim 1, further comprising returning a content of the management data to a state preceding issue of the license data in response to an uninstall notification of the software that is issued from the computer to the electronic device.

6. A method according to claim 1, wherein
the electronic device includes a contents playback device for recording and playing back contents transferred from the computer, and
the software has a function of managing contents transfer to the electronic device.

7. A method according to claim 6, wherein the software uses license data in the electronic device to perform authentication of whether the electronic device is rightful, and when authentication succeeds, transfers contents to the electronic device.

8. An electronic device capable of recording or playing back contents downloaded from a computer, comprising:
means for storing license data necessary for installing software for contents transfer from the computer to a contents playback device, or executing a specific function of the software, and management data for managing an issue history of the license data; and
means for, upon reception of a license data acquisition request from a computer connected to the contents playback device, determining permission or inhibition of issuing the license data for the acquisition request on the basis of the management data.

9. A device according to claim 8, further comprising:
means for returning a content of the management data to a state preceding issue of the license data in response to an uninstall notification of the software from the computer to the electronic device.

10. A computer-readable recording medium which records a computer program installed and used in a computer, wherein the computer program includes:
a procedure of, in installing the computer program or executing a specific function of the computer program, requesting acquisition of license data of an electronic device which stores license data necessary for installing the computer program or executing the specific function, and management data for managing an issue history of the license data; and
a procedure of permitting the install or the execution of the specific function on a condition that rightful license data is acquired from the electronic device.

11. A license management method for a contents playback device, comprising the steps of:
requesting, in installing a computer program or executing a specific function of the computer program, acquisition of license data of an electronic device which stores license data necessary for installing the computer program or executing the specific function, and management data for managing an issue history of the license data; and
permitting the install or the execution of the specific function on a condition that the rightful license data is acquired from the electronic device.
